(19) United States
(12) Patent Application Publication
(10) Pub. No.: US 2003/0090073 A1
(43) Pub. Date: May 15, 2003

(54) Wheelchair

(76) Inventor: Chih Chiang Whang, Hsin Tien City (TW)

Correspondence Address: BACON & THOMAS, PLLC, 625 SLATERS LANE, FOURTH FLOOR, ALEXANDRIA, VA, 22314

(21) Appl. No.: 09/984,586

(22) Filed: Oct. 30, 2001

(51) Int. Cl. B62D 39/00

(52) U.S. Cl. 280/33.991

(57) ABSTRACT

A wheelchair including a back, a seat pivotally turnably connected to and between two armrests forward extended from two sides of the back, a substantially trapezoidal underframe having a shorter front side and a longer rear side, and a footplate pivotally turnably connected to a front portion of the underframe. The footplate is normally in a horizontally extended position for a user of the wheelchair to stretch and rest two legs on the footplate. Both the seat and the footplate are turnable to an upright position to allow extension of the front portion of the underframe forward into a rear portion of an underframe of another wheelchair positioned in front of the wheelchair, so that two wheelchairs in tandem may be closely nested to occupy a reduced space.

### BACKGROUND OF THE INVENTION

The present invention relates to a wheelchair, and more particularly to a wheelchair having an underframe suitable for a user to rest two forward stretched legs thereon, and seat and footplate pivotally turnable to an upright position to enable extension of a front portion of the wheelchair forward into a rear portion of another wheelchair position before the wheelchair.

A conventional wheelchair is generally designed to meet the requirements of the invalid and is therefore not necessarily suitable for those having injured legs due to, for example, a fracture. That is, the conventional wheelchair does not include means for supporting forward stretched legs. Moreover, the conventional wheelchair includes seat and back mainly made of soft canvas or artificial leather that is tightly stretched between two side frames of the wheelchair. Particularly, the back is usually located at a selected section on the side frames to support only a limited upper part of an adult user's back. While the conventional wheelchair helps the invalid to move around, its back having a standardized height and a resting inclination might not be suitable for supporting a patient suffering from weak muscles or injured spine to relieve pains in the back and/or help support the injured back. In a worse condition, the conventional wheelchair might subject the patient suffering from spine or back injury to some side effects, such as a sideward bent spine. When a wheelchair fails to provide right support to the patient sitting thereon, the patient would inevitably feel uncomfortable after having sat on the wheelchair for a prolonged time.

Further, the conventional wheelchair usually includes knuckle joints to enable folding of the wheelchair into a reduced volume to facilitate easy storage thereof. However, not all the users could easily handle such knuckle joints to quickly collapse or extend the wheelchair.

It is therefore tried by the inventor to develop an improved wheelchair that includes means for supporting a user's forward stretched legs and includes a seat and a footplate pivotally turnable into an upright position to enable close position of two wheelchairs in tandem to occupy reduced storage space.

### SUMMARY OF THE INVENTION

A primary object of the present invention is to provide a wheelchair that includes means for supporting a user's forward stretched legs and includes a seat and a footplate pivotally turnable into an upright position to enable close position of two wheelchairs in tandem to occupy reduced storage space.

To achieve the above and other objects, the wheelchair of the present invention mainly including a back, a seat pivotally turnably connected to and between two armrests forward extended from two sides of the back, a substantially trapezoidal underframe having a shorter front side and a longer rear side, and a footplate pivotally turnably connected to a front portion of the underframe. The footplate is normally in a horizontally extended position for a user of the wheelchair to stretch and rest two legs on the footplate. Both the seat and the footplate are turnable to an upright position to allow extension of the front portion of the underframe forward into a rear portion of an underframe of another wheelchair positioned in front of the wheelchair, so that two wheelchairs in tandem may be closely nested to occupy a reduced space.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a wheelchair according to the present invention;

FIG. 2 shows the wheelchair of the present invention in use;

FIG. 3 shows two wheelchairs of the present invention are positioned in tandem to enable storage of the wheelchairs in a partially nested state;

FIG. 4 shows the two wheelchairs in tandem of FIG. 3 are moved closer to each other; and

FIG. 5 shows the two wheelchairs in tandem of FIG. 4 are moved into a closely nested state.

### DETAILED DESCRIPTION OF THE PREFERRED EMBODIMENTS

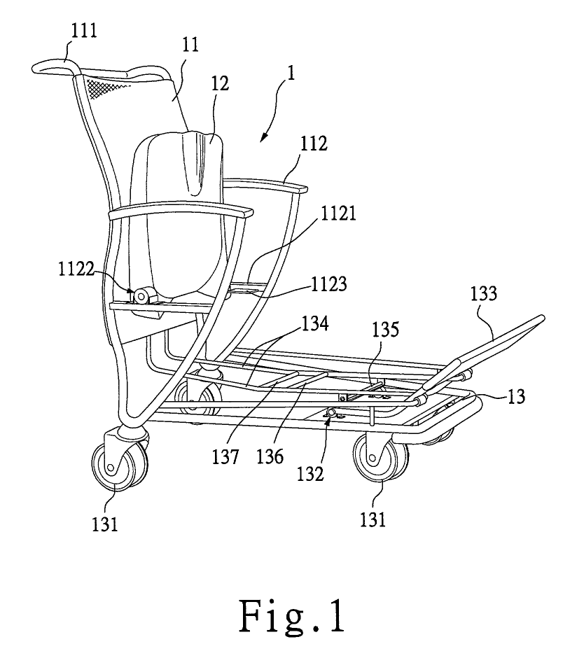

Please refer to FIG. 1 that is a perspective view of a wheelchair 1 according to the present invention. As shown, the wheelchair 1 mainly includes a back 11, a seat 12, and an underframe 13.

The back 11 has an increased height, as compared with most conventional wheelchairs, and is made into a curved contour generally corresponding to a human spine. The back 11 is provided at a top with a handle 111, and at two sides with two frame-like armrests 112, each of which has an intermediate crossbar 1121. A first elastic-restoring mechanism 1122 is provided near rear ends of the two intermediate crossbars 1121 for pivotally connecting to two rear corners of the seat 12, and a pair of supports 1123 provided at front ends of the two intermediate crossbars 1121 for bearing a user's weight sitting on the seat 12.

The seat 12 is a substantially rectangular member padded with a soft material and has a front portion formed into a substantially W-shaped curve. The seat 12 is pivotally connected at two rear corners to the first elastic-restoring mechanism 1122 so that it is normally pulled by the first elastic-restoring mechanism 1122 to an upright position close to the back 11 and could be easily turned downward to a horizontal position for sitting. Two lower front corners of the front portion of the seat 12 are rested on the pair of supports 1123 when the seat 12 is subjected to a downward pressure.

The underframe 13 of the wheelchair 1 is a substantially trapezoidal frame having a shorter front side and a longer rear side. The underframe 13 is provided at four corners of a bottom side with four wheels 131, and near two lateral sides of an upper front portion with a pair of second elastic-restoring mechanisms 132, to which a footplate 133 is pivotally connected to be normally held in a forward extended position for use and be backward turnable into a substantially upright position. A pair of guide rails 134 downward extends from a lower middle of the back 11 by a distance and then turns to extend forward and downward at a predetermined inclination to connect to a front end of the underframe 13. A retaining bar 135 is extended across a front portion of the two guide rails 134, and a locating bar 136 and a reinforcing bar 137 are sequentially provided behind the retaining bar 135 to extend across the pair of guide rails 134. The purpose of providing the locating bar 136 and the reinforcing bar 137 will be explained later.

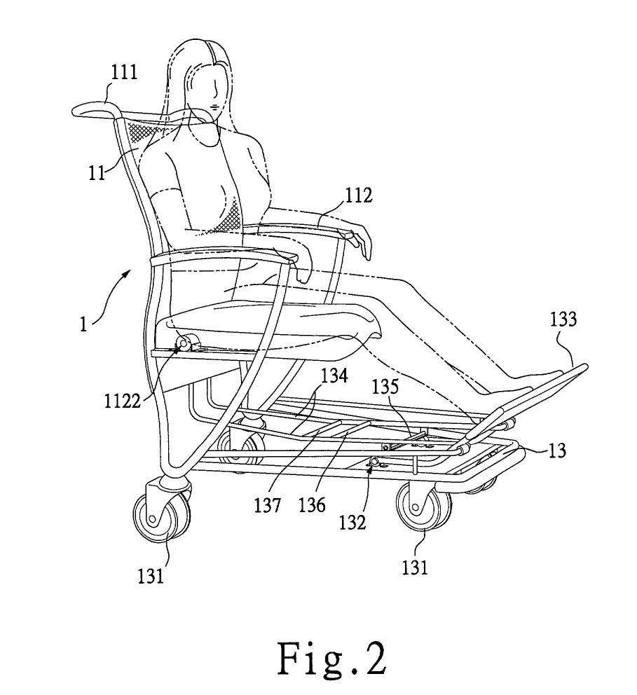

Please refer to FIG. 2. To prepare the wheelchair 1 for use, simply tilt the upright seat 12 downward to a horizontal position. A user may stretch two legs to rest two feet on the footplate 133 located in front of the underframe 13 or bend two knees for two soles to flatly contact with the top of the underframe 13. The back 11 having increased height provides support to the user's whole back. The W-shaped curve at the front portion of the seat 12 provides at a top of the seat 12 with two curved recesses, into which the user comfortably rests two thighs to evenly distribute the user's weight of thighs over the seat 12 and to help support the user's weight of spine, so that the user would not have stiff, sore and swollen legs even he or she has been sitting on the wheelchair for a long time. Problems of sideward bent spine and poor circulation of blood at legs may therefore be avoided.

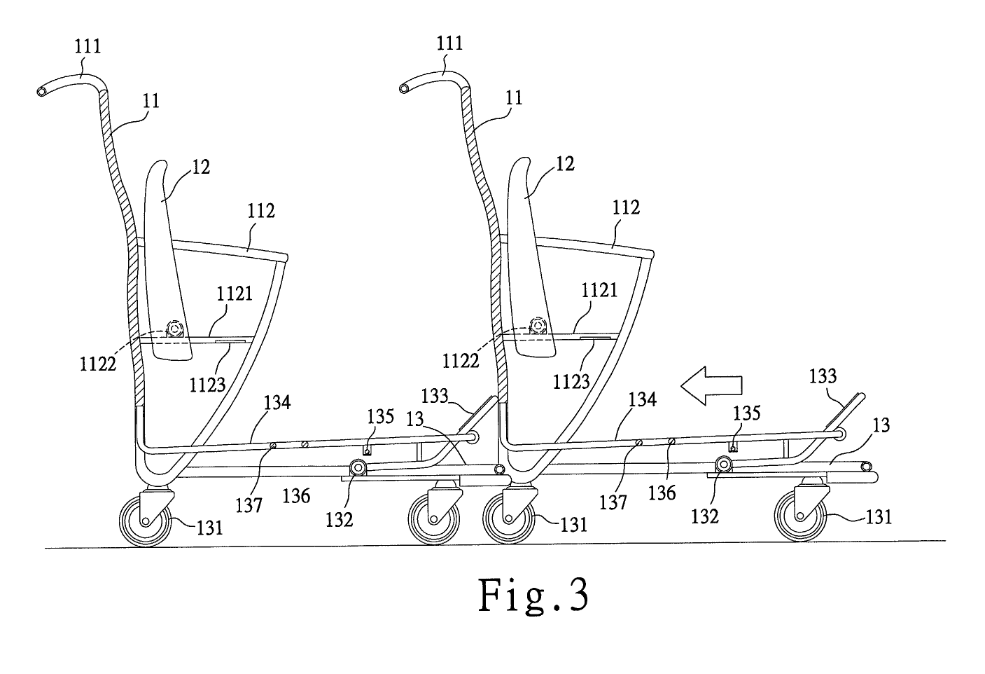

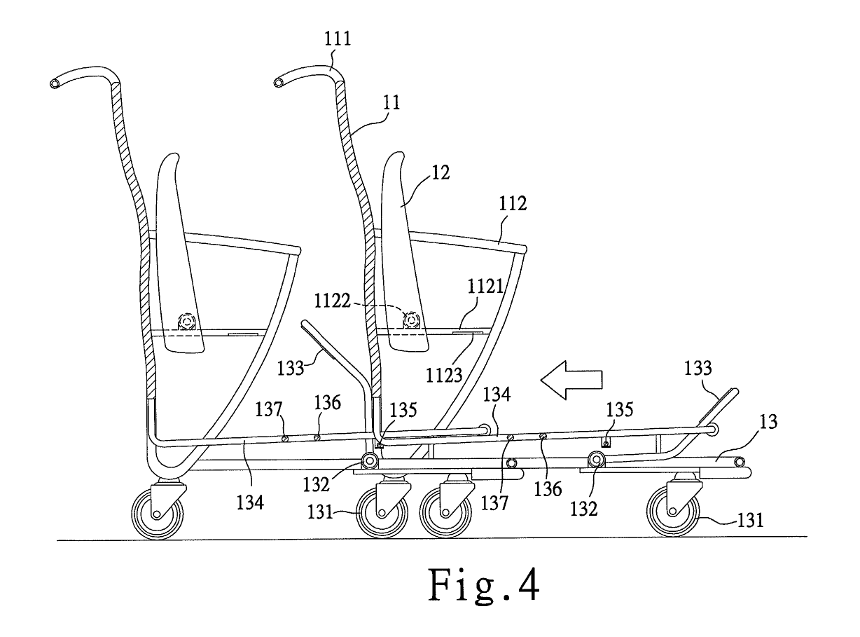

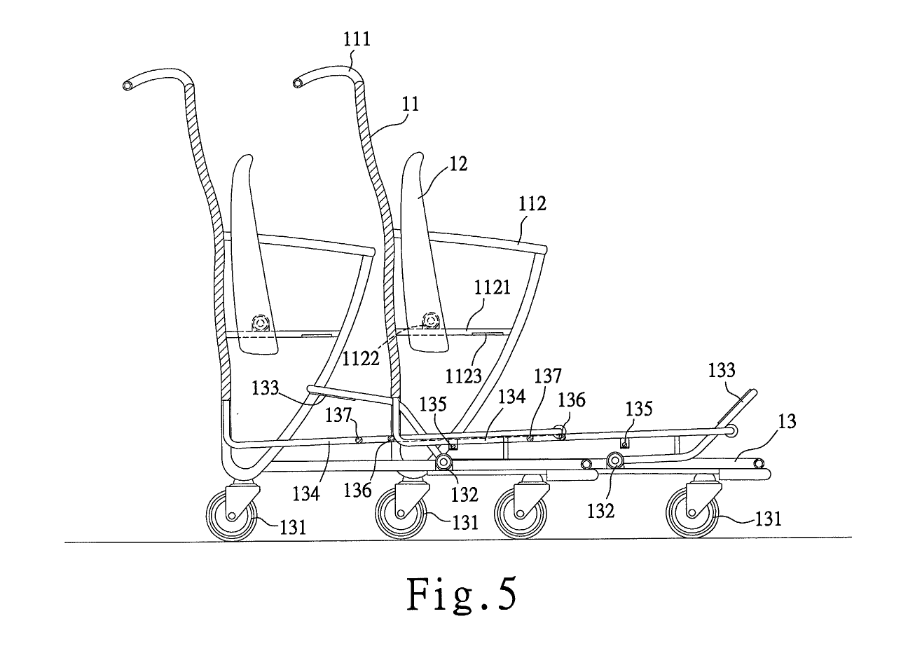

When there is more than one wheelchair 1 that is not in use, the wheelchairs 1 may be positioned in tandem and moved close to one another to reduce the space needed for storing these wheelchairs 1. Please refer to FIG. 3. When two wheelchairs 1 are positioned in tandem, a rear one of the two wheelchairs 1 maybe pushed forward to extend the front end of the underframe 13 into a rear end of a front one of the two wheelchairs 1. At this point, the footplate 133 of the rear wheelchair 1 would be pushed against the back 11 of the front wheelchair 1 and be gradually tilted backward from the horizontal position to the upright position, as shown in FIG. 4. When the retaining bar 135 on the pair of guide rails 134 of the rear wheelchair 1 is moved beyond lower bends of the two guide rails 134 of the front wheelchair 1, it would retain the front wheelchair 1 at the guide rails 134 and prevent the front wheelchair 1 from moving away from the rear wheelchair 1. When the locating bar 136 of the rear wheelchair 1 reaches at the lower bends of the two guide rails 134 of the front wheelchair 1, as shown in FIG. 5, it is located in place and slightly lifts two rear wheels 131 of the front wheelchair 1, preventing the front wheelchair 1 from automatically separating from the rear wheelchair 1. The wheelchair 1 of the present invention is therefore readily usable and may be conveniently nested in a front wheelchair 1 to occupy a limited space when it is not in use. And, it is noted the wheelchair 1 of the present invention is so structured that it is particularly suitable for patients having injured spine and leg or legs.

What is claimed is:

1. A wheelchair comprising a back, a seat pivotally turnably connected to and between two armrests forward extended from two sides of said back, a substantially trapezoidal underframe having a shorter front side and a longer rear side, and a footplate pivotally turnably connected to a front portion of said underframe; said footplate being normally in a horizontally extended position for a user of said wheelchair to stretch and rest two legs on said footplate, and both said seat and said footplate being turnable to an upright position to allow extension of said front portion of said underframe forward into a rear portion of an underframe of another said wheelchair positioned in front of said wheelchair.

2. The wheelchair as claimed in claim 1, wherein said back has a front surface made into a curve generally corresponding to human back and spine.

3. The wheelchair as claimed in claim 1, wherein said seat has a top front portion made into a W-shaped curve.

4. The wheelchair as claimed in claim 1, wherein said two armrests are two frames having an intermediate crossbar each, and said intermediate crossbars being provided at two rear ends with a first elastic-restoring mechanism with which said seat is pivotally connected to said two armrests, and at two front ends with two supports on which a front portion of said seat is supported.

5. The wheelchair as claimed in claim 1, wherein said underframe is provided at four corners of a bottom with four wheels, and at two sides of said front portion with a pair of second elastic-restoring mechanisms, with which said footplate is pivotally turnably connected to said underframe.

6. The wheelchair as claimed in claim 1, wherein said underframe includes a pair of guide rails downward extended from a lower middle of said back by a distance and then turned forward and downward at a predetermined inclination, and said pair of guide rails being provided near a front end with a transverse retaining bar, and behind said retaining bar with a transverse locating bar and a transverse reinforcing bar that strengthens a structural supporting ability of said guide rails.
